(19) United States
(12) Patent Application Publication
(10) Pub. No.: US 2009/0295714 A1
(43) Pub. Date: Dec. 3, 2009

(54) POWER CONSERVING SYSTEM FOR HAND-HELD CONTROLLERS

(75) Inventor: Craig S. Erickson, Stevenson Ranch, CA (US)

Correspondence Address: STOEL RIVES LLP - PDX, 900 SW FIFTH AVENUE, SUITE 2600, PORTLAND, OR, 97204-1268, US

(73) Assignee: IPPASA, LLC, Vancouver, WA (US)

(21) Appl. No.: 12/473,066

(22) Filed: May 27, 2009

Related U.S. Application Data
(60) Provisional application No. 61/056,270, filed on May 27, 2008.

(51) Int. Cl. G09G 5/00

(52) U.S. Cl. 345/156

(57) ABSTRACT

A manual controller operates through a wireless communication link with a computing device to manipulate images or symbols on a display associated with the computing device. An electrical power conserving system allows such a wireless controller to conserve electrical power as the controller operates with electrical power supplied by replaceable batteries or rechargeable battery packs. In preferred embodiments, electronic manual-contact sensing circuitry enables more rapid turnoff of the controller during periods of game play inactivity. This eliminates a long timeout period and allows electrical current drain only when the controller is actually being held by a user. Preferred embodiments of the electronic manual-contact sensing circuitry detect electrical resistance of a user's hands and thereby enables delivery of different amounts of electrical power as required.

### RELATED APPLICATION

This application claims benefit of U.S. Provisional Patent Application No. 61/056,270, filed May 27, 2008.

### TECHNICAL FIELD

The present disclosure relates to wireless hand-held game controllers and, in particular, to an electrical power conserving system that enables such wireless controllers to conserve electrical power as they operate with electrical power supplied by replaceable batteries or rechargeable battery packs. Preferred embodiments of the power conserving system detect electrical resistance of a user's hands and thereby enables delivery of different amounts of electrical power as required.

### BACKGROUND INFORMATION

Wireless hand-held game controllers operate with electrical power supplied by limited battery power sources and necessitate either battery recharging or replacement. A constant game play power demand requires that the controllers operate most efficiently in their consumption of power. Conserving electrical power also especially applies to premium controllers that have added power requirements stemming from, for example, cooling devices such as blowers or fans, or special player feedback devices typically such as vibration, forced feedback, or lighting. Such added features place an even greater demand upon their limited power sources.

The typical solution for limiting power consumption is use of a fixed time period that forces the microprocessor unit (MPU) of the controller into a watchdog sleep state, in which the power consumption is diminished to a bare minimum. The beginning of this sleep state occurs after no buttons on the controller have been pressed and after the expiration of a typical countdown or timeout period that typically varies from 3 minutes to 10 minutes. During this timeout period, the controller is fully powered but unused for actual game play. If the controller has requirements for additional power in amounts required by premium controllers, such as power requirements imposed by forced air cooling, there is an even greater demand on the battery power source. The constant drain of power in this manner accumulates, especially with shorter times of game play, and will force an even greater cumulative loss of power. This can be exacerbated during game play if there are numerous pauses between game play sequences, during which the buttons are not pressed for a time shorter than the timeout period so that the unit remains activated and does not time out into the lowest drain mode.

### SUMMARY OF THE DISCLOSURE

In exemplary embodiments of the present disclosure, electronic manual-contact sensing circuitry enables more rapid turn off of the controller during periods of game play inactivity. This eliminates a long timeout period and allows electrical current drain only when the controller is actually being held by a user. In one embodiment, the sensing circuitry is of a resistive type that is implemented with a Darlington Pair transistor circuit to sense resistance of the user's hand. The Darlington Pair circuit senses a condition in which the user no longer holds the controller and thereby allows the controller or just the primary electrical current draining accessories to be turned off. The sensing circuitry itself also draws a small, minor amount (microamperes) of electrical current, which may even further be eliminated by allowing only the sensing circuitry itself to be powered while a main microprocessor unit (MPU) in the controller is operational. In this embodiment, the timeout period of the MPU may be lowered to 15 seconds, after which the controller not only deactivates the functions of the controller, and goes into a watchdog state low drain sleep mode, but also turns off all power to the sensing circuitry to eliminate the minor sensing circuitry current drain.

In another embodiment, the actual power setting of a device, such as a cooling blower or fan, exhibiting larger electrical current drain can have its speed set automatically. This can be accomplished by measuring the average typical skin resistance of the user and allowing the device to consume a greater amount of electrical current when less resistance is measured and consume less electrical current when presence of the user's hand is detected and more resistance is measured. In this manner, the actual power drain can be further meted out as required, generally based upon whether a user's hand is determined to be sweating or not sweating.

Additional aspects and advantages will be apparent from the following detailed description of preferred embodiments, which proceeds with reference to the accompanying drawings.

### BRIEF DESCRIPTION OF THE DRAWINGS

FIGS. 1A and 1B are, respectively, exploded and isometric views of a manual controller configured for two-handed operation and equipped with manual-contact sensing strips on its left- and right-hand grips.

FIG. 2 is a typical Darlington Pair transistor circuit of a type that allows sensing of electrical conductivity through the hand skin of a user holding the controller.

FIG. 3 is a block diagram of the major components of the controller processing signals produced by the manual-contact sensing strips of FIGS. 1A and 1B.

### DETAILED DESCRIPTION OF PREFERRED EMBODIMENTS

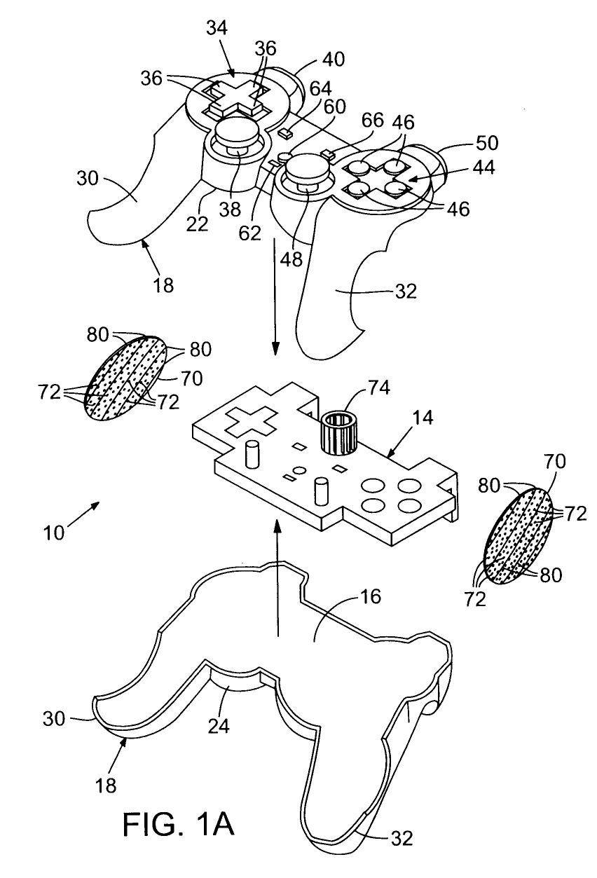

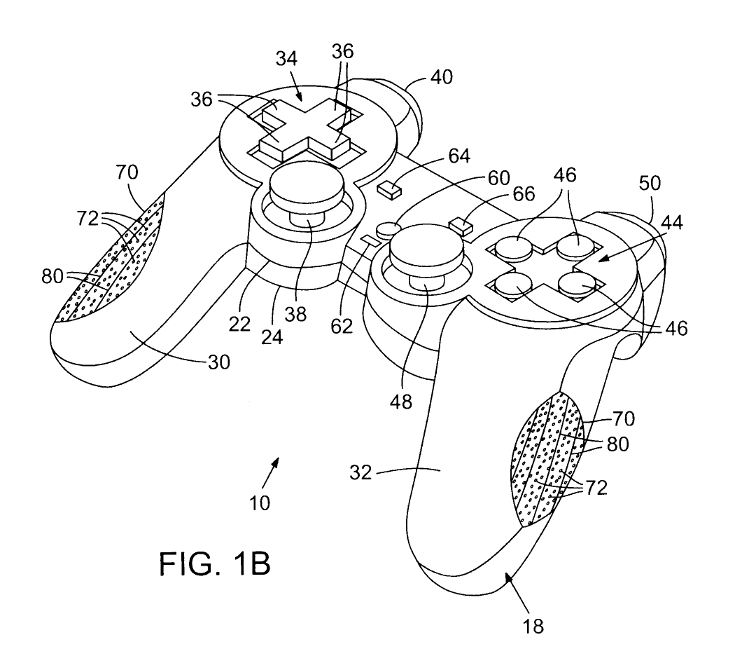

FIGS. 1A and 1B are, respectively, exploded and isometric views of a preferred embodiment of a manual controller 10 that operates through a wireless communication link with a computing device (not shown) to manipulate images or symbols on a display associated with the computing device. Manual controllers for manipulating images or symbols on a visual display of a computing device include, for example, joysticks, game pads, steering wheels, guns, and mice for video games; remote devices for television, DVD, VCR, stereophonic equipment, projectors, and other such electronic equipment; cellular telephones; and portable video game systems.

With reference to FIG. 1, manual controller 10 includes an internal electronics assembly 14 contained within an interior region 16 of a housing 18 preferably formed of hard plastic. In this preferred embodiment, manual controller 10 is assembled by placing internal electronics assembly 14 between an upper housing shell section 22 and a lower housing shell section 24. Upper and lower shell sections 22 and 24 are assembled to form a unitary casing for internal electronics assembly 14. Housing 18 has a left-hand grip 30 and a right-hand grip 32 for two-handed gripping by a user. A left-side control pad 34 including four pressable control members 36, left-side analog stick control 38, and front left-side control button 40 are positioned for access by the digits of the user's left hand; and a right-hand control pad 44 including four control buttons 46, right-side analog stick control 48, and front right-side control button 50 are positioned for access by digits of the user's right hand. A mode selection switch 60, mode indicator 62, selection button 64, and start button 66 are positioned between hand grips 30 and 32. Skilled persons will appreciate that the above-described number of control function actuators, control function actuator layout pattern, and hand grip arrangement represent only one of numerous possible control function actuator and hand grip configurations.

Each of left-hand grip 30 and right-hand grip 32 has on its lateral side an opening into which fits a perforated plastic grip insert 70 of generally elliptical shape. Grip inserts 70 form outer surface gripping regions. Perforations or holes 72 in grip inserts 70 allow flow of air propelled by a cooling fan or blower mechanism 74 installed in interior region 16 of housing 18 to reach the palms of a user's hands covering grip inserts 70 while gripping hand grips 30 and 32. Four elongated manual-contact sensing elements or strips 80 extend along the length of and intersect each of grip inserts 70. For each grip insert 70, two spaced-apart contact sensing strips 80 are located on, or alternatively embedded in, the surface of each of upper and lower shell sections 22 and 24. This arrangement allows for eight contact sensing strip locations to efficiently sense whether a user is holding controller 10.

Contact sensing strips 80 shown in FIG. 1 are of an electrical resistance sensing type and are typical of and similar to those made for pulse rate monitors used in exercise equipment. Contact sensing strips 80 are composed of electrically conductive metal to sense the electrical conductivity of a user's hand when it holds controller 10. The purpose of contacting strips 80 is to allow the circuitry of electronics assembly 14 to measure the electrical resistance between them and thereby determine whether controller 10 is being held. The amount of sensed electrical conductivity can be used to produce an additional controller output signal to control, for example, the speed of blower mechanism 74 and therefore the rate of forced airflow to the user's hands. Manual-contact sensing elements 80 may be in other than elongated strips, such as, for example, solid areas applied to or formed as an integral part of the design of housing 18. Another option is to spray in place electrically conductive contact areas, which would serve the same purpose.

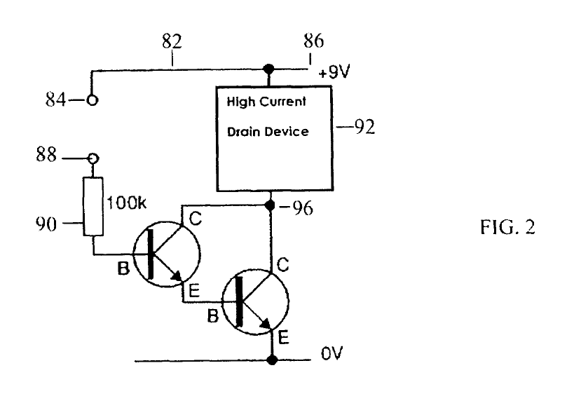

FIG. 2 shows a typical Darlington Pair transistor circuit 82 to which are connected two of contact sensing strips 80 affixed to one of hand grips 30 and 32. With reference to FIG. 2, one of contact sensing grips 80 is electrically connected to a positive terminal 84 of a power supply 86, which is shown as a 9-volt battery, and to an input terminal end 88 of a resistor 90 of Darlington Pair circuit 82. Darlington Pair circuit 82 senses the electrical current present across a high resistance surface, such as the skin of a user's hand. Whenever Darlington Pair circuit 82 senses the presence of the skin of a user's hand holding controller 10, electrical current flows to a high current drain load device 92, such as cooling blower mechanism 74 (FIG. 1A) that is connected to a collector terminal junction 96 forming an output of Darlington Pair circuit 82. A manual controller equipped with a forced air blower mechanism to cool a game player's hands is disclosed in U.S. Pat. No. RE 39,409.

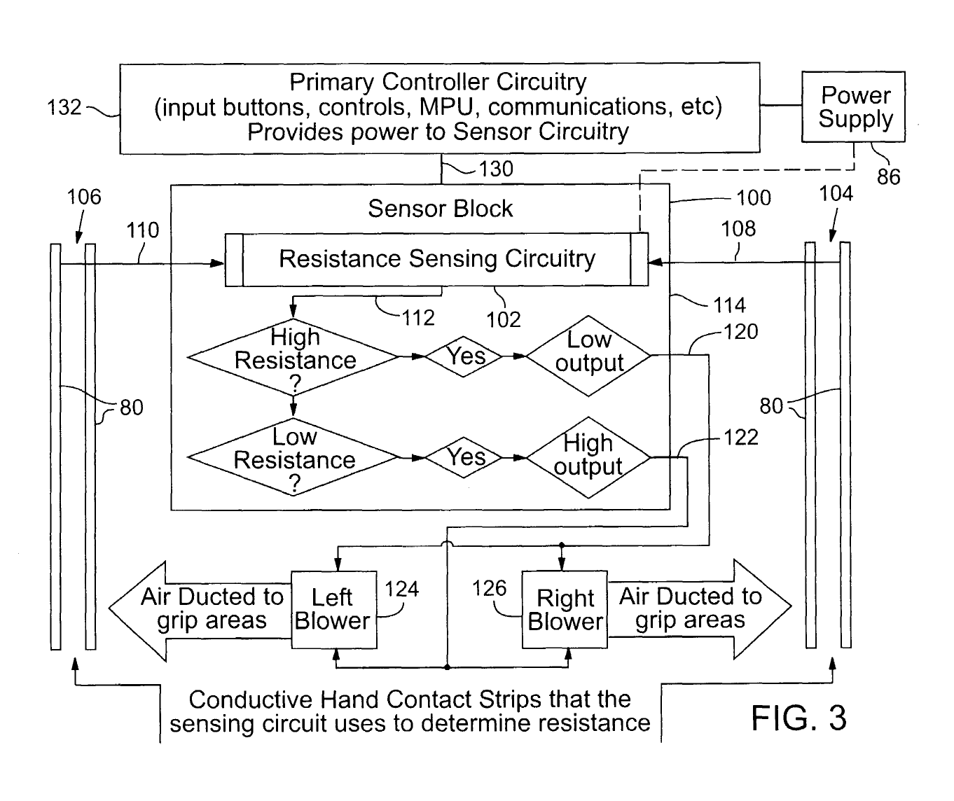

FIG. 3 is a hybrid block diagram of system components of controller 10 and an embedded flow diagram of a control signal decision sequence performed by a resistance sensing system component of controller 10. With reference to FIG. 3, a sensor block 100 includes electrical resistance sensing circuitry 102 that detects the electrical resistance between different pairs 104 and 106 of contact sensing strips 80. Specifically, pair 104 of contact sensing strips 80 is applied to an input 108 of resistance sensing circuitry 102, such as to different ones of input terminals of a first Darlington Pair circuit of a type similar to Darlington Pair circuit 82, and pair 106 of contact sensing strips is applied to an input 110 of resistance sensing circuitry 102, such as to different ones of input terminals of a second Darlington Pair circuit of a type similar to Darlington Pair circuit 82. An output 112 of resistance sensing circuitry 102 is applied to a processor section 114 (depicted as flow diagram decision and process blocks of FIG. 3) to deliver appropriate amounts of electrical current at outputs 120 and 122 of sensor block 100 to a left grip blower 124 and a right grip blower 126. Blowers 124 and 126 are components of blower mechanism 74 that forms part of internal electronics assembly 14 and constitute high current-drain load devices, such as load device 92 shown in FIG. 2.

Sensor block 102 receives signals delivered on a communication link 130 between sensor block 100 and primary controller circuitry 132, the latter of which includes user-actuated buttons and switches such as those described above for control pads 34 and 44, a main MPU, wireless communication circuitry, and electrical power delivery conductors, all of which are available in a conventional wireless game controller. Power supply 86 has an interruptible device connection to primary controller circuitry 132, which in certain embodiments delivers over communication link 130 electrical power to resistance sensing circuitry 102.

Power conservation in the operation of controller 10 can be achieved in any one of several embodiments.

In a first embodiment, the main MPU of primary controller circuitry 132 delivers electrical power to resistance sensing circuitry 102 separately from the remainder of sensor block 100 and is set to a timeout period (e.g., 15 minutes). Upon expiration of the set timeout period during which there is no user gripping of contact sensing strips 80 and no actuation of a control button or switch, primary controller circuitry 132 delivers electrical power only to resistance sensing circuitry 102. This first embodiment allows resistance sensing circuitry 102 to drive the high-current drain load devices 92 such as lights, blowers, Peltier junctions, and pumps only when the main MPU is powered and only when resistance sensing circuitry 102 senses that controller 10 is being held by a user.

In a second embodiment, power supply 86 can be of a constant voltage type and continuously applied to resistance sensing circuitry 102 to keep it always in an activated state. This second embodiment enables application of no electrical power to all of the remaining components of controller 10, thereby keeping them in an unpowered, nonactivated state until resistance sensing circuitry 102 senses that controller 10 is being held by a user. Upon sensing a user holding controller 10, resistance sensing circuitry 102 delivers a signal that activates the interruptible device connection between power supply 86 and primary controller circuitry 132 to cause application of electrical power to the main MPU.

In a third embodiment, resistance sensing circuitry 102 can be set to sense the average resistance of the user's hands holding controller 10 and apply electrical current appropriately to drive blower mechanism 74 at a higher level of performance to provide greater airflow when a lesser resistance (indicative of perspiring hands of the user) has been detected by sensing circuitry 102. This operational performance can be accomplished by the circuitry of the embodiment of controller 10 shown in FIG. 3.

Electrical power is applied to resistance sensing circuitry 102 when primary controller circuitry 132 is activated and operational. To save on battery power consumption, no electrical power is typically applied when primary controller circuitry 132 is not operating. Resistance sensing circuitry 102 detects the electrical resistance between members of each pair 104 and 106 of contact sensing strips 80. If the measured resistance is low (indicating high conductivity), then the signals produced at outputs 120 and 122 provide higher electrical power to a left grip blower 124 and a right grip blower 126, thereby driving them at a faster speed to increase airflow output. If the measured resistance is high (indicating low conductivity), then the signals produced at outputs 120 and 122 provide lower electrical power to left grip blower 124 and right grip blower 126, thereby driving them at a lower speed to decrease airflow output. This then equates to more use of power only when generally necessary and thereby less consumption of battery capacity. As described for the second embodiment, it is practical to consider that resistance sensing circuitry 102, when powered all the time, can also provide electrical power to activate primary controller circuitry 132. In this manner, the typical timeout period functionality of primary controller circuitry 132 would not be required because electrical power applied to it would be eliminated when resistance sensing circuitry 102 has sensed that controller 10 is not being held.

In a fourth embodiment, user adjustable settings are interposed between outputs 120 and 122 to grip blowers 124 and 126 and the electrical power provided by resistance sensing circuitry 102. This configuration enables by user adjustable settings further division into higher and lower airflow outputs, even when sensor block 100 delivers at outputs 120 and 122 signals commanding a higher or lower airflow output from grip blowers 124 and 126.

The above examples represent only general examples of how sensing of a user's hand can be achieved. Skilled persons will appreciate that other typical sensing circuits such as those implemented with capacitive, inductive, temperature, or pressure sensing technology, alternatively with use of operational amplifiers, comparators, or similar circuitry, can also be employed. The embodiments described demonstrate the primary spirit of the disclosure and are not meant to limit the nature of the concept.

It will be obvious to those having skill in the art that many changes may be made to the details of the above-described embodiments without departing from the underlying principles of the invention. The scope of the invention should, therefore, be determined only by the following claims.

1. An electrical power-conserving system for a hand-held controller that includes electrical power-consuming controller components, comprising:
a controller housing having an outer surface that is hand gripped by a user during operation of the controller;
manual-contact sensing material positioned in or on the outer surface of the controller housing;
manual-contact sensing circuitry operatively connected to the manual-contact sensing material to produce a control signal in response to user contact with the manual-contact sensing material, the control signal having a value that is indicative of whether the user is gripping the manual-contact sensing material; and
processing circuitry responsive to the control signal to cause a set of the electrical power-consuming components to assume a nonactivated state, thereby to reduce electrical power consumption by the set of the electrical-power consuming components and overall electrical power consumption by the controller.

2. The system of claim 1, in which the manual-contact sensing material is of an electrical resistance sensing type.

3. The system of claim 2 in which the manual-contact sensing material comprises multiple elements positioned at different locations in or on the outer surface of the controller housing.

4. The system of claim 1, in which the controller is of a wireless type and includes a battery power supply.

5. The system of claim 1, in which the controller comprises controller circuitry that is operatively connected to a power supply and that includes control function actuators and a processing unit, and further comprising a communication link between the controller circuitry and the manual-contact sensing circuitry for transmission of electrical power and the control signal, the processing unit being set to a timeout period and, upon receipt over the communication link of a control signal value indicating no user gripping of the controller and upon no receipt of an indication of actuation of at least one of the control function actuators during the timeout period, enabling transmission of electrical power over the communication link to the manual-contact sensing circuitry as the set of the electrical power-consuming components rest in the nonactivated state.

6. The system of claim 5, in which the manual-contact sensing material is of an electrical resistance sensing type.

7. The system of claim 1, in which the controller comprises controller circuitry that has an interruptible device connection to a power supply, the interruptible device connection being responsive to the control signal, and in which the manual-contact sensing circuitry is operatively connected to the power supply, the interruptible device connection causing the controller circuitry to rest in an unpowered, nonactivated state, and upon occurrence of a control signal value indicating user gripping of the controller, causing application of electrical power by the power supply to the controller circuitry.

8. The system of claim 7, in which the manual-contact sensing material is of an electrical resistance sensing type.

9. The system of claim 1, in which the manual-contact sensing material is of an electrical resistance sensing type and in which the set of power-consuming components includes a forced air blower mechanism, the manual contact sensing circuitry capable of producing multiple values of the control signal, the multiple values of the control signal representing different values of measured electrical resistance that indicate corresponding amounts of hand skin perspiration of the user hand gripping the controller, and the processing circuitry causing the forced air blower mechanism to produce airflow in lesser and greater amounts in response to, respectively, higher and lower values of the measured electrical resistance.

10. The system of claim 9, in which the controller housing includes a left-hand grip and a right-hand grip for two-handed gripping by a user and in which the forced air blower mechanism includes a left grip blower and a right grip blower that direct the produced airflow along separate flow paths to, respectively, the left hand and the right hand of the user.
